(19) United States
(12) Patent Application Publication
(10) Pub. No.: US 2007/0097452 A1
(43) Pub. Date: May 3, 2007

(54) Image forming apparatus for generating stable horizontal sync signal and method thereof

(75) Inventor: Se-Tae Kim, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/482,802

(22) Filed: Jul. 10, 2006

(30) Foreign Application Priority Data
Nov. 3, 2005 (KR) 2005-104843

(51) Int. Cl. H04N 1/40

(52) U.S. Cl. 358/471

(57) ABSTRACT

An image forming apparatus for generating a stable horizontal sync signal and a horizontal sync signal generating method are provided. The image forming apparatus includes a switching unit to switch on an electric current according to a video signal, a light output unit to output an optical power corresponding to the electric current, which is switched on by the switching unit, an optical power controller to control an intensity of the electric current switched on by the switching unit, and a printer engine unit to output an optical power control voltage to amplify the intensity of the switched-on electric current during a horizontal sync signal generation period included in the video signal. Accordingly, a stable horizontal sync signal is generated, and the deterioration of the quality of a print job is prevented.

### CROSS-REFERENCE TO RELATED APPLICATION

This application claims the benefit under 35 U.S.C. §119(a) of Korean Patent Application No. 2005-0104843, filed Nov. 3, 2005 in the Korean Intellectual Property Office, the entire disclosure of which is hereby incorporated by reference.

### BACKGROUND OF THE INVENTION

1. Field of the Invention

The present invention relates to an image forming apparatus for generating a stable horizontal synchronization (hereinafter “sync”) signal and a method thereof. More particularly, the present invention relates to an image forming apparatus and method for minimizing a temporal variation occurring during a detection of a horizontal sync signal and generating a stable horizontal sync signal to improve the quality of a print job.

2. Description of the Related Art

An image forming apparatus, such as laser printer, focuses a laser beam output from a laser diode onto a photoconductive drum to form an electrostatic latent image. The image forming apparatus completes a printing operation by applying toner on the electrostatic latent image and transferring a toner image to printing paper.

FIG. 1 shows the structure of a laser scanning unit employed in a conventional image forming apparatus.

Referring to FIG. 1, the conventional image forming apparatus comprises a laser diode 10, a collimating lens 11, a cylinder lens 12, a polygon mirror 13, a motor 14, an f theta (fθ) lens 15, a reflection mirror 16, a photoconductive drum 17, a horizontal sync mirror 18, and an optical sensor 19.

The laser diode 10 is used as a light source and outputs a laser beam. The collimating lens 11 converts the laser beam output from the laser diode 10 into a parallel beam. The cylinder lens 12 focuses the parallel beam output from the collimating lens 11 on the polygon mirror 13. The polygon mirror 13 is driven by the motor 14 to reflect the laser beam transmitted through the cylinder lens 12 at a predetermined angle.

The f theta (fθ) lens 15 may have a constant refraction ratio in accordance with an optical axis. The f theta (fθ) lens 15 corrects an aberration of the laser beam reflected by the polygon mirror 13 and focuses the laser beam on an accurate point of a scanning surface. The reflection mirror 16 reflects the laser beam passing through the f theta (fθ) lens 15 in a predetermined direction and makes it incident on a surface of the photoconductive drum 17 on which an image is formed.

The horizontal sync mirror 18 reflects the laser beam passing through the f theta (fθ) lens 15 in a horizontal direction and makes it incident on the optical sensor 19. The optical sensor 19 receives the laser beam reflected from the horizontal sync mirror 18 and outputs an electric horizontal sync signal. A printer engine (not shown) receives the electric horizontal sync signal and uses it to correct an error occurring between scanning lines.

FIGS. 2A to 2C are views explaining a jitter occurring in the horizontal sync signal generated by the conventional image forming apparatus.

For example, FIG. 2A shows a video signal that forms a one-line image on the printing paper. The laser beam output from the laser diode 10 during a horizontal sync signal generation period is reflected by the horizontal sync mirror 18 and received by the optical sensor 19. The laser beam output from the laser diode 10 during an image generation period is reflected by the reflection mirror 16 and is incident on the surface of the photoconductive drum 17, thereby forming an electrostatic latent image.

FIG. 2B is a graph showing a variation of the horizontal sync signal according to the intensity of the laser beam received at the optical sensor 19. FIG. 2C is a graph showing the degree of the jitter occurring in the horizontal sync signal according to the intensity of the laser beam.

The optical sensor 19 outputs the horizontal sync signal when the intensity of the laser beam output from the laser diode 10 during the horizontal sync signal generation period reaches a certain threshold. The threshold may have a variable value (range C) rather than a fixed value. Therefore, the variation occurs at the time the horizontal sync signal is output.

For example, if the intensity of the laser beam is high (A), a temporal variation exists between the horizontal sync signal outputs. Additionally, if the intensity of the laser beam is low (B), a temporal variation exists between the horizontal sync signal outputs. When the intensity of the laser beam is low, the temporal variation is widened and the degree of the jitter occurring in the horizontal sync signal output from the optical sensor 19 increases.

When the temporal variation between the horizontal sync signal outputs is widened, an error occurring between scanning lines cannot be accurately corrected and a uniform image signal cannot be output. This causes the quality of the print job to deteriorate.

Light sources which use a low intensity of light are used more frequently as the types of light sources are verified and the light receiving efficiency of the photoconductive drum 17 increases. Therefore, the temporal variation between the horizontal sync signal outputs is widened. This causes the quality of a print job to deteriorate.

Accordingly, there is a need for an improved system and method for minimizing a temporal variation occurring during a detection of a horizontal sync signal and generating a stable horizontal sync signal to improve the quality of a print job.

### SUMMARY OF THE INVENTION

An aspect of exemplary embodiments of the present invention is to address at least the above problems and/or disadvantages and to provide at least the advantages described below. Accordingly, an aspect of exemplary embodiments of the present invention is to provide an image forming apparatus to generate a stable horizontal sync signal. The stable horizontal sync signal is generated when an intensity of the laser beam generated during a horizontal sync signal generation period is increased and when a temporal variation between the horizontal sync signal outputs is minimized.

The above aspect is achieved when an image forming apparatus is provided. The image forming apparatus includes a switching unit to switch on an electric current according to a video signal, a light output unit to output an optical power corresponding to the electric current, which is switched on by the switching unit, an optical power controller to control an intensity of the electric current switched on by the switching unit, and a printer engine unit to output an optical power control voltage to amplify the intensity of the switched-on electric current during a horizontal sync signal generation period included in the video signal.

In an exemplary implementation, the printer engine unit outputs an optical power control voltage. The optical power control voltage is greater than an average voltage and is output during the horizontal sync signal generation period.

In another exemplary implementation, the light output unit outputs an optical power which is amplified based on the optical power control voltage during the horizontal sync signal generation period.

In a further exemplary implementation, the light output unit includes at least one of a laser diode and a vertical cavity surface emitting laser (VCSEL).

The above aspect is also achieved by providing a method for generating a horizontal sync signal. An electric current is switched on according to a video signal and an optical power control voltage is output to amplify an intensity of the switched-on electric current during a horizontal sync signal generation period included in the video signal. The intensity of the switched-on electric current is controlled based on the optical power control voltage and an optical power corresponding to the switched-on electric current is output.

When an optical power corresponding to the switched-on electric current is output, an optical power amplified during the horizontal sync signal generation section period based on the optical power control voltage is output.

An image forming apparatus is also provided to achieve the above aspect. The image forming apparatus includes a plurality of light output units, an optical sensor, a plurality of switching units, and a printer engine unit. The plurality of light output units is mounted according to a physical position difference to one another. The optical sensor detects lights output from the plurality of light output units. The plurality of switching units switch on the plurality of light output units in sequence. The printer engine unit controls the optical switching units so that the lights output from the plurality of light output units are detected by the optical sensor at the same time.

In another exemplary implementation, the printer engine controls the plurality of switching units to satisfy the following equation:
scanning line velocity×Δt_{D}≦D

wherein Δt_{D} denotes a temporal difference between two lights which are activated and D denotes a space between two lights.

In a further exemplary implementation, the printer engine unit controls the plurality of switching units to satisfy the following equation:
scanning line velocity×Δt_{OVERLAP}≦W

wherein Δt_{OVERLAP} denotes a time when four lights are commonly received at the optical sensor and W denotes a light receiving width of the optical sensor.

Other objects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other objects, features, and advantages of certain exemplary embodiments of the present invention will be more apparent from the following description taken in conjunction with the accompanying drawings, in which:

FIG. 1 is a view illustrating a laser scanning unit employed in a conventional image forming apparatus;

FIGS. 2A to 2C are views explaining a jitter occurring in a horizontal sync signal generated in the conventional image forming apparatus;

FIG. 3 is a block diagram illustrating an image forming apparatus according to an exemplary embodiment of the present invention;

FIG. 4 is a view explaining a method for stabilizing a horizontal sync signal generated by the image forming apparatus according to an exemplary embodiment of the present invention;

FIG. 5 is a flowchart illustrating the operation of the image forming apparatus according to an exemplary embodiment of the present invention;

FIG. 6 is a block diagram schematically illustrating an image forming apparatus according to another exemplary embodiment of the present invention; and

FIG. 7 is a view explaining a method for stabilizing a horizontal sync signal generated by the image forming apparatus according to another exemplary embodiment of the present invention.

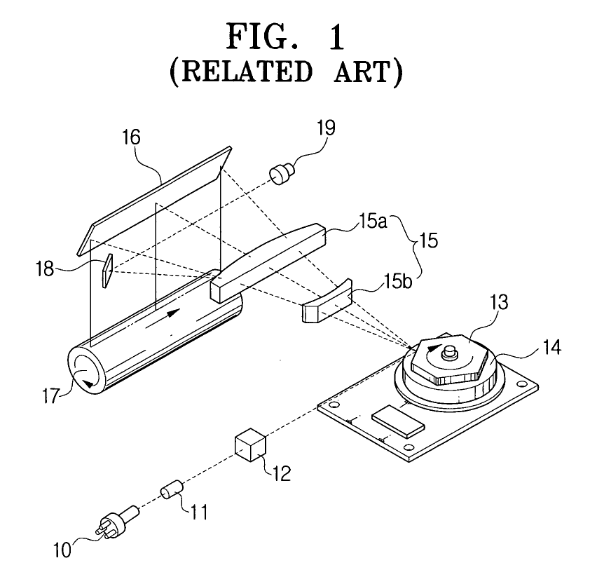

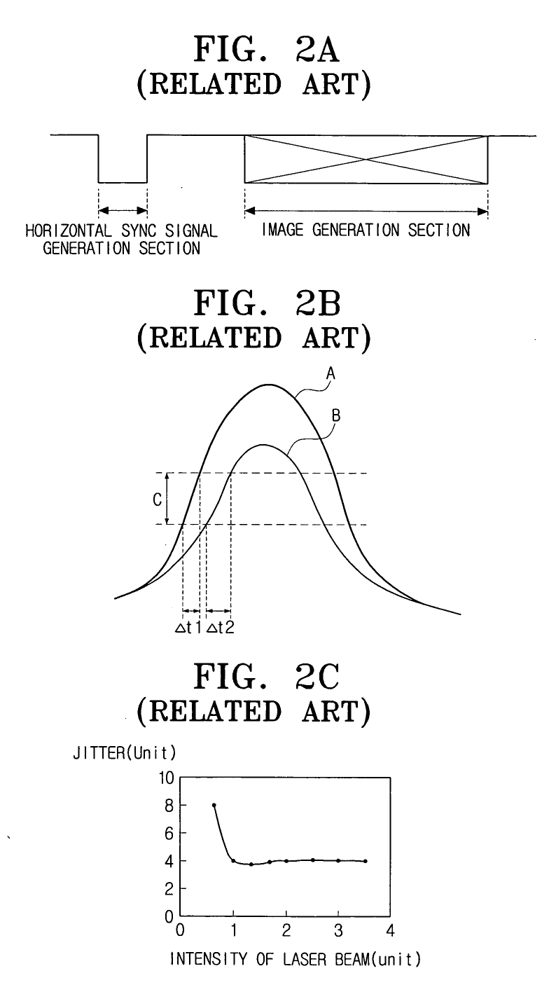

Throughout the drawings, the same drawing reference numerals will be understood to refer to the same elements, features, and structures.

### DETAILED DESCRIPTION OF EXEMPLARY EMBODIMENTS

The matters defined in the description such as a detailed construction and elements are provided to assist in a comprehensive understanding of the embodiments of the invention. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

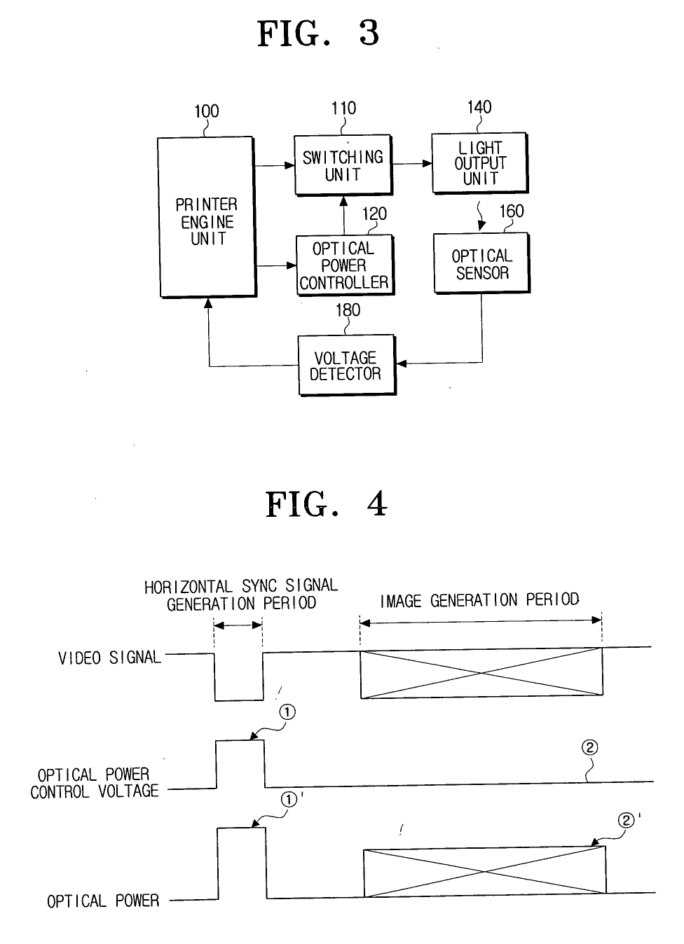

FIG. 3 is a block diagram illustrating an image forming apparatus according to an exemplary embodiment of the present invention.

Referring to FIG. 3, the image forming apparatus comprises a printer engine unit 100, a switching unit 110, an optical power controller 120, a light output unit 140, an optical sensor 160, and a voltage detector 180.

The printer engine unit 100 comprises a video controller (not shown) to output a video signal and an optical power control voltage. The video signal corresponds to an image to be printed on printing paper and the optical power control voltage adjusts the intensity of light output from the light output unit 140. The optical power control voltage typically ranges from 0.6V to 2.0V and may have a constant average voltage of 1.5V in the related art. According to an exemplary embodiment of the present invention, the printer engine unit 100 outputs a voltage grater than the average voltage during a horizontal sync signal generation period.

The switching unit 110 switches an electric current on or off according to the video signal output from the printer engine unit 100. For example, the switching unit 110 is switched on during the horizontal sync signal generation period and a predetermined level of electric current is applied to the power output unit 140. Also, the switching unit 110 is switched on or off according to the video signal during an image generation period and applies the electric current to the light output unit 140 or stops the electric current supply.

The optical power controller 120 controls the level of electric current, which is switched on by the switching unit 110, according to the optical power control voltage output from the printer engine unit 100. That is, the optical power controller 120 amplifies the level of electric current switched on by the switching unit 110 according to the voltage which is output from the printer engine unit 100 during the horizontal sync signal generation period and may have a greater value than the average voltage.

The light output unit 140 generates a light according to the electric current switched on by the switching unit 110 and outputs the light. The light output unit 140 uses a laser diode or a vertical cavity surface emitting laser (VCSEL).

The optical sensor 160 receives the light output from the light output unit 140 and outputs an electric signal. That is, the optical sensor 160 receives the light output from the light output unit 140 during the horizontal sync signal generation period, and outputs the electrical signal until the intensity of the received light reaches a certain threshold and decreases beyond the threshold. This electrical signal is referred to as a horizontal sync signal.

The voltage detector 180 detects the horizontal sync signal output from the optical sensor 160 and transmits the horizontal sync signal to the printer engine unit 100. The printer engine unit 100 starts to output the video signal based on the detected horizontal sync signal to form an image during the image generation period.

FIG. 4 is a view explaining a method for stabilizing the horizontal sync signal generated by the image forming apparatus according to an exemplary embodiment of the present invention.

The video signal is output from the video controller (not shown) included in the printer engine unit 100 and includes the horizontal sync signal generation period and the image generation period.

The optical power control voltage is also output from the printer engine unit 100, and is output in the level of \textcircled{1} during the horizontal sync signal generation period and output in the level of \textcircled{2} during the other remaining period.

The optical power is output from the switching unit 110 in the level of \textcircled{1}′ during the horizontal sync signal generation period and output in the level of \textcircled{2}′ during the image generation period.

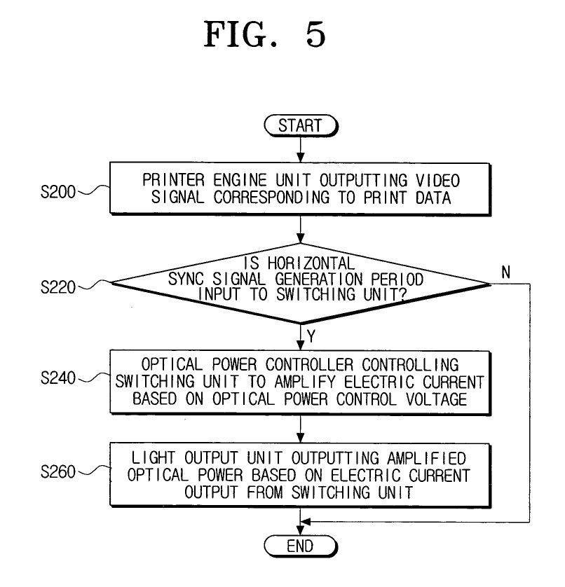

FIG. 5 is a flowchart illustrating the operation of the image forming apparatus according to an exemplary embodiment of the present invention.

Referring to FIG. 5, the printer engine unit 100 outputs a video signal corresponding to print data at step S200. The output video signal includes a horizontal sync signal generation period and an image generation period.

When the horizontal sync signal generation period is input to the switching unit 110 at step S220, the optical power controller 120 controls the switching unit 110 to amplify the intensity of electric current according to an optical power control voltage. That is, the optical power controller 120 amplifies the intensity of electric current, which is switched on by the switching unit 110, according to the optical power control voltage output from the printer engine unit 100 during the horizontal sync signal generation period at step S240.

The light output unit 140 outputs the optical power amplified by the electric current output from the switching unit 110 at step S240. Through the above-described process, a stable horizontal sync signal is generated.

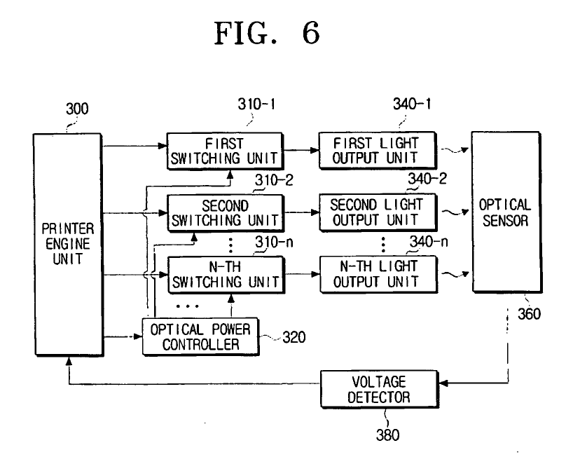

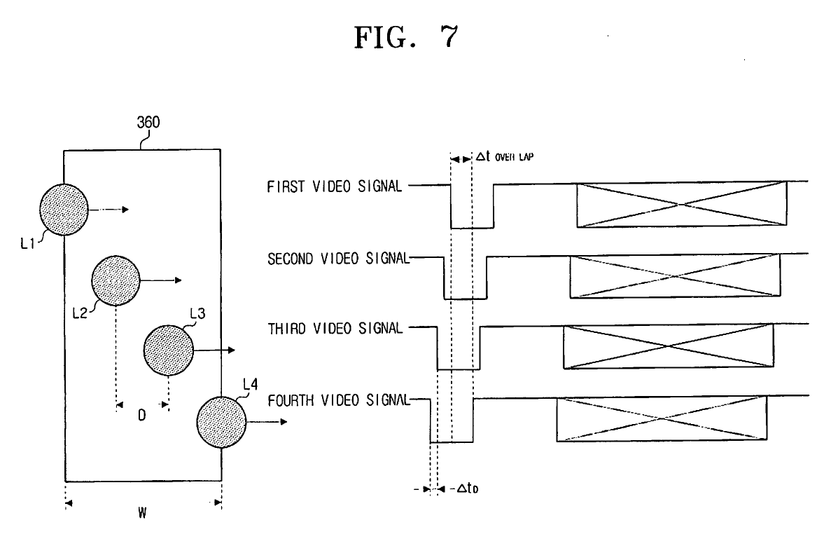

FIG. 6 is a block diagram illustrating an image forming apparatus according to another exemplary embodiment of the present invention.

The image forming apparatus illustrated in FIG. 6 comprises a plurality of first through N-th light output units 340-1, 340-2, . . . , 340-n and a plurality of first through N-th switching units 310-1, 310-2, . . . , 310-n. The first through N-th switching units 310-1, 310-2, . . . , 310-n switch an electric current to be applied to the first through the N-th light output units 340-1, 340-2, . . . 340-n.

A printer engine unit 300 outputs a constant level of optical power control voltage unlike the embodiment shown in FIG. 3. As shown in FIG. 4, the printer engine unit 300 outputs an optical power control voltage in the level of \textcircled{2} during both the horizontal sync signal generation period and the other remaining period. The printer engine unit 300 outputs a video signal so that a first video signal output through the first light output unit 340-1 and an N-th video signal output through the N-th light output unit 340-n are overlapped during the horizontal sync signal generation period.

The first through the N-th switching units 310-1, 310-2, . . . , 310-n switch on electric currents according to the output video signal and supply the electric currents to the first through the N-th light output unit 340-1, 340-2, . . . 340-n. An optical power controller 320 controls the first through the N-th switching units 310-1, 310-2, . . . , 310-n to make the switched-on electric currents equal.

The first through the N-th light output units 340-1, 340-2, . . . 340-n output the same level of optical power according to the electric currents switched on by the first through the N-th switching units 310-1, 310-2, . . . , 310-n. The output lights are received at the optical sensor 360. The optical sensor 360 receives all the lights output from the first through the N-th light output units 340-1, 340-2, . . . , 340-n, and accordingly, the intensity of optical power received at the optical sensor 360 increases in proportion to the number of received lights.

FIG. 7 is a view explaining a method for stabilizing the horizontal sync signal generated by the image forming apparatus according to another exemplary embodiment of the present invention.

FIG. 7 illustrates 4 light output units, in which the first through fourth lights L1, L2, L3, L4 received at the optical sensor 360 have the same level of optical power. The printer engine unit 300 outputs the first through fourth video signals to satisfy the following equation 1 or 2 to activate all the first through the fourth lights L1, L2, L3, L4 when they pass through the optical sensor 360:
scanning line velocity×Δt_{D}≦D [Equation 1]

wherein the scanning line velocity is a rotation velocity of a polygon mirror (not shown), Δt_{D} denotes a temporal difference between two lights which are activated, and D denotes a space between two lights.
scanning line velocity×Δt_{OVERLAP}≧W [Equation 2]

wherein Δt_{OVERLAP} denotes a time that the four lights are commonly activated and received at the optical sensor 360, and W denotes a light receiving width of the optical sensor 360.

According to the above condition, the intensity of optical power received at the optical sensor 360 is amplified so that a stable horizontal sync signal is output.

According to an exemplary embodiment of the present invention as described above, the temporal variation between the horizontal sync signal outputs is minimized by increasing the intensity of optical power generated during the horizontal sync signal generation period, so that the stable horizontal sync signal can be generated and the deterioration of the quality of the print job can be prevented.

While the present invention has been shown and described with reference to certain exemplary embodiments thereof, it will be understood by those skilled in the art that various changes in the form and details may be made therein without departing from the spirit and scope of the invention as defined by the appended claims and their equivalents.

What is claimed is:

1. An image forming apparatus comprising:
a switching unit to switch on an electric current according to a video signal;
a light output unit to output an optical power corresponding to the electric current, which is switched on by the switching unit;
an optical power controller to control an intensity of the electric current switched on by the switching unit; and
a printer engine unit to output an optical power control voltage to amplify the intensity of the switched-on electric current during a horizontal sync signal generation period included in the video signal.

2. The image forming apparatus as claimed in claim 1, wherein the printer engine unit outputs an optical power control voltage, which is greater than an average voltage, during the horizontal sync signal generation period.

3. The image forming apparatus as claimed in claim 1, wherein the light output unit outputs an optical power which is amplified based on the optical power control voltage during the horizontal sync signal generation period.

4. The image forming apparatus as claimed in claim 1, wherein the light output unit comprises at least one of a laser diode and a vertical cavity surface emitting laser (VCSEL).

5. A method for generating a horizontal sync signal of an image forming apparatus, comprising:
switching on an electric current according to a video signal;
outputting an optical power control voltage to amplify an intensity of the switched-on electric current during a horizontal sync signal generation period included in the video signal;
controlling the intensity of the switched-on electric current based on the optical power control voltage; and
outputting an optical power corresponding to the switched-on electric current.

6. The method as claimed in claim 5, wherein the outputting of an optical power corresponding to the switched-on electric current outputs an optical power amplified during the horizontal sync signal generation period based on the optical power control voltage.

7. An image forming apparatus comprising:
a plurality of light output units mounted to have a physical position difference with respect to one another;
an optical sensor to detect lights output from the plurality of light output units;
a plurality of switching units to switch on the plurality of light output units in sequence; and
a printer engine unit to control the optical switching units so that the lights output from the plurality of light output units are detected by the optical sensor at the same time.

8. The image forming apparatus as claimed in claim 7, wherein the printer engine controls the plurality of switching units to satisfy the following equation:
scanning line velocity×Δt_{D}≦D
wherein Δt_{D} denotes a temporal difference between two lights which are activated and D denotes a space between two lights.

9. The image forming apparatus as claimed in claim 7, wherein the printer engine unit controls the plurality of switching units to satisfy the following equation:
scanning line velocity×Δt_{OVERLAP}≧W
wherein Δt_{OVERLAP} denotes a time that four lights are commonly received at the optical sensor, and W denotes a light receiving width of the optical sensor.

10. The image forming apparatus as claimed in claim 1, wherein the optical power controller amplifies the level of electric current switched on by the switching unit according to the voltage output from the printer engine.

11. The image forming apparatus as claimed in claim 1, further comprising an optical sensor to receive light output from the light output unit and for outputting an electrical signal.

12. The image forming apparatus as claimed in claim 11, wherein the optical sensor receives light output from the light output unit during the horizontal sync signal generation period, and outputs the electrical signal until the intensity of the received light reaches a certain threshold and decreases beyond the threshold.

13. The image forming apparatus as claimed in claim 11, further comprising a voltage detector to detect a horizontal sync signal output from the optical sensor and to transmit the horizontal sync signal to the printer engine unit.

14. The method as claimed in claim 5, wherein the horizontal sync signal generated by the image forming apparatus is stabilized.
